(19) United States
(12) Patent Application Publication
(10) Pub. No.: US 2004/0074370 A1
(43) Pub. Date: Apr. 22, 2004

(54) Guitar pick comprising a blend of plastic and magnetically receptive material

(76) Inventor: John Jeffrey Oskorep, Chicago, IL (US)

Correspondence Address: JOHN J. OSKOREP, ESQ., ONE MAGNIFICENT MILE CENTER, 980 N. MICHIGAN AVE., SUITE 1400, CHICAGO, IL, 60611, US

(21) Appl. No.: 10/365,985

(22) Filed: Feb. 13, 2003

Related U.S. Application Data
(60) Provisional application No. 60/421,125, filed on Oct. 22, 2002.

(51) Int. Cl. G10D 3/16

(52) U.S. Cl. 84/322

(57) ABSTRACT

In one illustrative example, a guitar pick holder is made of a thin, planar, and visually appealing magnet which adheres to a front outside surface of a guitar. A guitar pick which is used with the holder is made of a combined blend of plastic and magnetically receptive material (e.g. iron). The blend of materials provides the guitar pick with a sufficient magnetic attraction so that it can be magnetically held against the magnet, while simultaneously providing a flexibility, durability, and “look and feel” of a conventional synthetic pick. The guitar pick may be magnetized as well. A vinyl or polyester material may be provided over at least a portion of the surface of the guitar pick to provide for coloring or decoration, as such guitar picks are placed “on display” for the guitar.

### CROSS-REFERENCE TO RELATED APPLICATIONS

This application claims priority to a U.S. provisional patent application entitled “Magnetic Guitar Pick Holding System” having U.S. Serial No. 60/421,125 and a filing date of Oct. 22, 2002, hereby incorporated by reference herein. This application also claims priority to a U.S. patent application entitled “Guitar Pick Holder Made Of A Flexible Magnetic Body” having U.S. Ser. No. 10/348,056 and a filing date of Jan. 21, 2003, hereby incorporated by reference herein.

### BACKGROUND

1. Field of the Invention

The present invention relates generally to the field of guitar picks and guitar pick holders, and more particularly to a guitar pick comprising a combined blend of plastic and magnetically receptive material for being magnetically attracted to a magnetic material.

2. Description of the Problem

A guitar is typically played with a “guitar pick”, which is used to strike or pluck strings of the guitar. Many guitar players carry a number of guitar picks with them as they are relatively small, easily lost, and inexpensive. However, it is often inconvenient to store or retrieve guitar picks. Guitar picks are typically carried in pants pockets and/or within guitar cases and need to be retrieved when the guitar is played. When a guitar is taken out of its guitar case, for example, a guitar pick must be retrieved from some location. Conversely, when a guitar is placed back in its case, the guitar pick must be stored somewhere. When a guitar player is playing and accidentally drops or intentionally tosses away the guitar pick, it is desirable to be able to quickly retrieve another one.

The majority of guitar picks are made from a plastic or synthetic material using a plastic injection molding technique or an extrusion technique. These guitar picks provide a desired flexibility and durability, and guitar players have grown accustomed to the “look and feel” of such plastic guitar picks. Although some guitar picks are made entirely of a metal or (perhaps) a metal alloy, such guitar picks are not as popular as plastic guitar picks. In addition, the appearance of guitars and guitar picks are fairly important to guitar players, and therefore it is preferable that any method used to hold or carry guitar picks does not detract from how these items look. Furthermore, guitar picks should be inexpensively made so that they may become commercially available and ubiquitous to a large number of consumers. Promotional and marketing techniques are also important in the industry.

Accordingly, what is needed is a guitar pick which solves at least some of the aforementioned problems.

### SUMMARY

In one illustrative example, a guitar pick holder is made of a magnetic material which provides a front magnetic surface for use in magnetically attracting a guitar pick and a rear adhering surface for use in adhering the holder to a surface of a guitar. The holder is preferably made from a flexible magnet that is thin, flat, and formed into a decorative shape to provide a visually appealing design for the guitar.

According to the present application, a guitar pick which is suitable for use with such a guitar pick holder has a guitar pick body formed from a blend of plastic -and magnetically receptive material. The magnetically receptive material may be or include iron (e.g. fine iron powder), for example, which is dispersed or distributed within the guitar pick body. The guitar pick body may be formed from the blend using, for example, an injection molding process or an extrusion process. The guitar pick may be magnetized as well.

Advantageously, such a blend of materials provides the guitar pick with a sufficient magnetic attraction so that it can be magnetically carried against and with the magnet, while simultaneously providing flexibility, durability, and the “look and feel” of a conventional synthetic pick.

A die-cut vinyl or polyester material may be provided over at least a portion of the guitar pick's surface to provide for coloring and/or decoration. This is preferred since such guitar picks are placed “on display” for the guitar. Colored, holographic, and/or “glow-in-the-dark” laminates provide good decorative qualities, attractive marketing to different audiences, and good visibility for pick retrieval. Such guitar picks can also be made at a relatively low cost for ubiquitous use.

### BRIEF DESCRIPTION OF THE DRAWINGS

FIG. 1 is an illustration of a guitar with a guitar pick holding system which includes a flexible magnet and a guitar pick made from a blend of plastic and magnetically receptive material;

FIG. 2 is a close-up illustration of the guitar pick holding system of FIG. 1 in use with the guitar;

FIG. 3 is a cross-sectional view of the guitar pick holding system of FIGS. 1-2;

FIG. 4 is a perspective view of the flexible magnet which has a removable backing sheet which covers an adhering surface thereof; and

FIG. 5 is an illustration of one example of a guitar pick of the present application, showing a hidden internal view of a magnetically receptive material (e.g. a magnetically receptive metal such as iron) dispersed within the synthetic or plastic material.

### DETAILED DESCRIPTION OF THE PREFERRED EMBODIMENTS

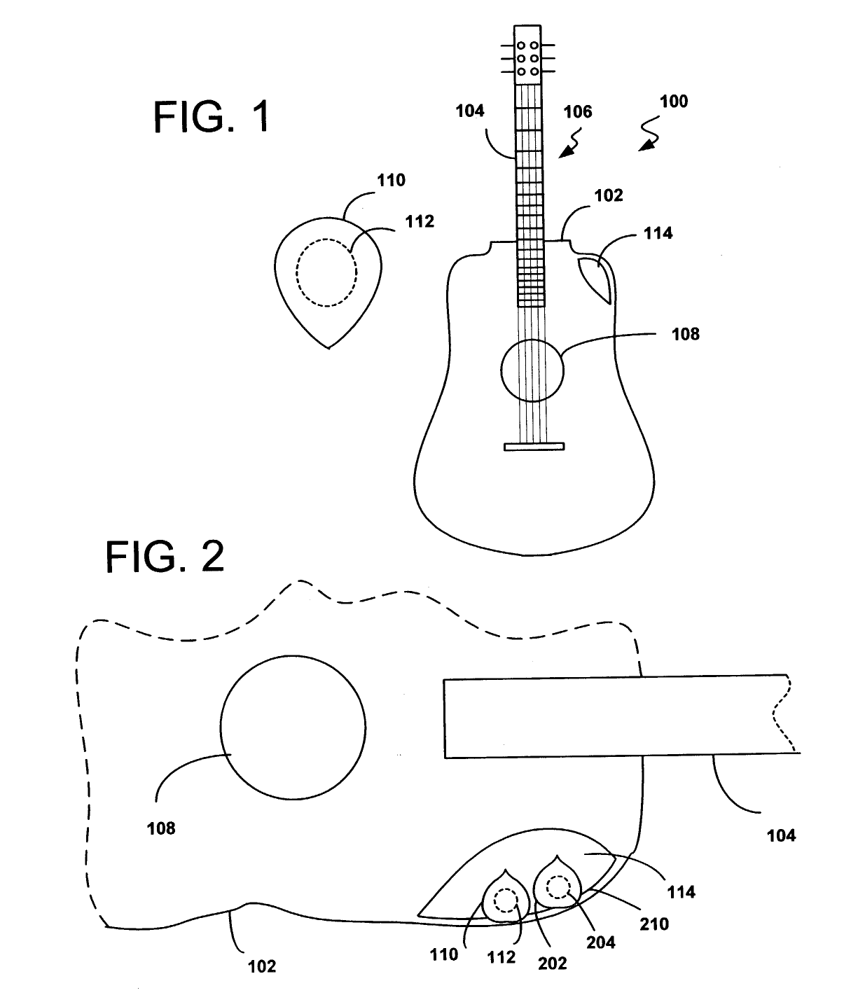

FIG. 1 is an illustration of a guitar 100 and a guitar pick 110 for use in connection with a guitar pick holder of the present application. Guitar 100 is a conventional acoustic guitar having a guitar body 102, a neck 104, a sound hole 108, and a plurality of guitar strings 106 (six in total). Guitar 100 may alternatively be an electrical guitar, such as a 6-string electric guitar or a bass guitar. Guitar body 102 is typically made of wood, but could be made of other suitable materials and include a lamination. Typically, guitar body 102 has a transparent or translucent gloss finish. The plurality of guitar strings 106 are typically made of steel, some of which may be wound with nickel.

Guitar pick 110, which is shown in FIG. 1 in enlarged view relative to guitar 100, is typically made of a flexible or resilient synthetic material, such as a plastic (e.g. nylon, delrin, tortex, celluloid, acetal, etc.). In this application, however, guitar pick 110 also includes a magnetically receptive material 112. Magnetically receptive material 112 is any suitable material that is attracted by magnetic forces, and includes materials such as a metal (e.g. iron, nickel, cobalt, etc.), metal alloys, magnetic material, and others. Magnetically receptive material 112 is shown in dotted lines in FIG. 1 as it is generally contained within guitar pick 110.

A guitar pick holder which is used to magnetically carry guitar pick 110 is made from a flexible magnetic body 114. Flexible magnetic body 114 has a rear adhering surface for use in adhering to a surface of guitar body 102 and a front magnetic surface for use in magnetically carrying guitar pick 110. In general, a flexible magnet is a magnet that is flexible. Rubber or plastic is generally used in combination with magnetic material (e.g. ferrite magnetic powder) for making such a flexible magnet. Integrally formed together, these materials are typically used to make common “refrigerator” magnets. As an example, a flexible rubber magnet is basically a composite material which combines ferrite magnetic powder and compound rubber. Due to its characteristics, a rubber magnet can be easily formed into any complicated shape. Unlike a hard ferrite magnet which is normally fragile against to shock, a rubber magnet is flexible and not easy to break or crack. It may be manufactured with appropriate flexibility and cut into any size with a knife or scissors (or die cut) to meet a specific requirement. Flexible magnetic sheets, with or without adhering backing surfaces, may be obtained from any suitable manufacturer or company such as from Magnetic Specialty Inc. having offices at 707 Gilman Street, Marietta, Ohio, 45750, USA.

In FIG. 2, a close-up illustration of the guitar pick holding system of FIG. 1 in use with the guitar is shown. As shown, guitar pick 110 is held and carried over the outside front surface of guitar body 102 due to its magnetic attraction to flexible magnetic body 114, which is adhered to the guitar's front surface. This remains true even when the guitar is held in the position shown (i.e. guitar pick 110 being subject to downward gravitational forces) and even when it is subject to relatively strong forces of accelerative motion (i.e. guitar body 102 is physically handled or shaken). Advantageously, the magnetic forces provided by flexible magnetic body 114 are sufficiently large enough to magnetically carry guitar pick 110 with guitar body 102 but also sufficiently small enough so as not to interfere with any electronics used in connection with the guitar.

Preferably, flexible magnetic body 114 is positioned along a front bottom edge (right-handed perspective) above sound hole 108 of guitar 100, as shown in FIGS. 1 and 2. However, any suitable areas of attachment may be utilized. FIG. 2 also shows that additional guitar picks 202 having magnetically receptive material 204 may be included in the system. Preferably, flexible magnetic body 114 is thin (e.g. less than 5 mm or 0.2 inches in thickness) and has a length of between about 7.6-12.7 cm (between about 3-5 inches) to simultaneously accommodate a number of different guitar picks. Preferably, flexible magnetic body 114 has sufficient flexibility to maintain conformity to curved surfaces of guitar body 102 (e.g. curved side edges) if desired or needed.

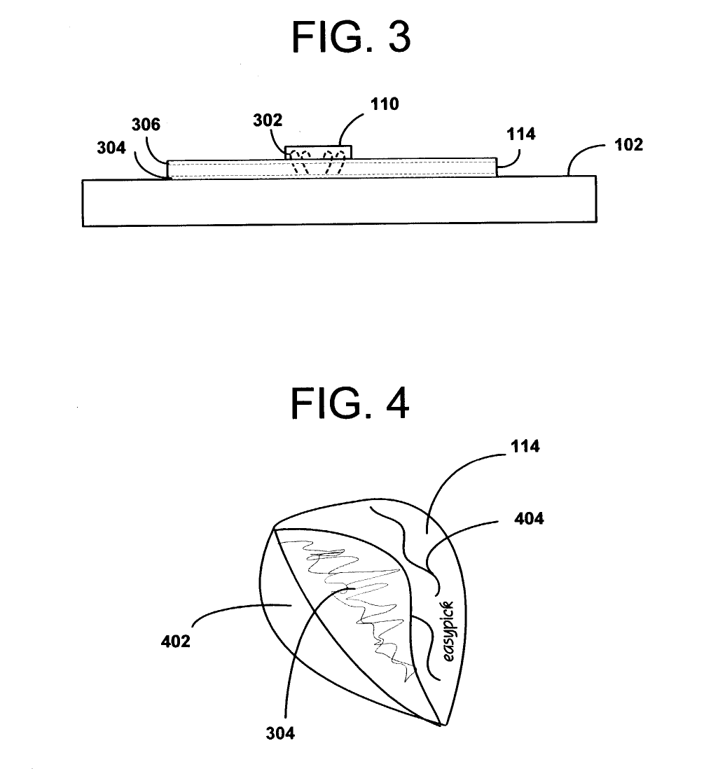

FIG. 3 is a cross-sectional view of the guitar pick holding system on guitar body 102 of FIG. 2. Thicknesses and relative thicknesses of the materials are exaggerated in FIG. 3 for illustrative purposes only. As shown, an adhering layer 304 is provided on a first surface of flexible magnetic body 114 opposite a second surface which provides a magnetic field 302 for attracting guitar pick 110. Adhering layer 304 provides for a semi-permanent attachment of flexible magnetic body 114 to guitar body 102. The rear adhering surface of flexible magnetic body 114 is preferably planar so that it conforms and adheres well to a variety of non-planar surfaces (e.g. curved side edges) as well as planar surfaces of a guitar body 102.

Preferably, adhering layer 304 is a static cling vinyl layer. This static cling vinyl layer may be adhesively attached to the rear surface of flexible magnetic body 114. Static cling vinyl is typically used for decorative purposes, such as for seasonal window graphics, signs, decals, or protective masking applications. Static cling vinyl is a special formulation of polyvinyl chloride (PVC) to which a large amount of plasticizer (a liquid) has been added. This highly plasticized formulation is very pliable. The vinyl is typically calendered to give it a smooth finish. When such film is applied to a smooth glossy surface (e.g. a guitar body), it adheres firmly without the need for an adhesive. Because there is no adhesive, application is very easy and it can be removed and reapplied nearly indefinitely.

Such static cling vinyl materials may be obtained from any suitable manufacturer or company, such as from Beacon Graphics having offices at 189 Meister Avenue, Somerville, N.J., 08876, USA. Although a particular formulation for static cling vinyl has just been described, other formulations may exist or be devised and the term “static cling vinyl” is intended to include such other alternative formulations which achieve the same results. Also, it is contemplated that the flexible magnet materials and static cling vinyl materials could be integrally formed or blended together in the same flexible magnetic body.

Some guitar surfaces have a nitrocellulose lacquer, which may be marred by plasticized PVC. In an alternate embodiment, adhering layer 304 of flexible magnetic body 114 is an adhesive layer. The adhesive may be a heavy adhesive or light temporary adhesive, and preferably one which leaves no adhesive residue (e.g. an adhesive which provides for reapplication and repositioning, such as a Post-It™ notes type adhesive by Spencer Silver) and provides an impermanent bond. Most manufacturers typically provide flexible magnetic sheets with an optional adhesive backing. More particularly, a low-tack micro-voided adhesive, called Supercling, is available from Plastiprint, Inc. of 445 Union Boulevard, Suite 209, Lakewood, Colo., 80228 USA. In yet another alternate embodiment, adhering layer 304 includes metal or magnetic material, which provides flexible magnetic body 114 with a magnetic attraction to a guitar body which has a metal or magnetic material surface.

As shown in the illustration of FIG. 4, flexible magnetic body 114 may also be provided with a removable backing sheet 402 over adhering layer 304 which is removed prior to attachment of flexible magnetic body 114 to guitar body 102. This removable backing sheet 402 is provided especially where adhering layer 304 includes a static cling vinyl or adhesive surface. If static cling vinyl is used, a clearcoat or glossy coating surface may be utilized.

Referring back to FIG. 3, similar to the rear adhering surface, the front magnetic surface of flexible magnetic body 114 is preferably planar. A planar front magnetic surface provides a good “sliding” action for easy removal of guitar pick 110 (e.g. the thumb may press and slide the pick off the edge of guitar body 102, where it is captured between the thumb and index finger). In the case where the front magnetic surface is formed to be planar, there may be a concern that guitar pick 110 will tend to slide off of guitar body 102 due to forces of gravity or accelerative motion (e.g. sudden guitar movements). However, magnetic field 302 over this surface is made sufficient such that guitar pick 110 normally remains held against flexible magnetic body 114 even when guitar body 102 is physically handled and shaken. Although magnetic forces 302 provided by flexible magnetic body 114 are sufficiently large enough to magnetically hold guitar picks in this manner, they are also sufficiently small enough so as to not interfere with any electronics used in connection with the guitar.

As shown in FIG. 3, a layer 306 of printed coloring and/or design (and/or a gloss finish) may be provided over the front magnetic surface of flexible magnetic body 114. A brand name may also be provided on the viewable surface, as shown in FIG. 4, which may additionally or alternatively include a visual design 404 or graphics image, a company name, a company logo, a band name, a band logo, or a band player's name. To provide such a layer of coloring, design, and/or text, any suitable technique may be used such as screen printing, label printing, offset printing, or colored laminates including vinyl or paper. As a preferred example, a black or white glossy vinyl “sticker” material may be provided on the front magnetic surface of flexible magnetic body 114. As another preferred example, a holographic material may be formed or cut to fit the front magnetic surface. Holographic vinyl materials are available from manufacturers or companies such as Amagic Holographics, Inc. of Irvine, Calif., U.S.A. As another preferred example, a glow-in-the-dark material may be formed or cut to fit the front magnetic surface. Glow-in-the-dark vinyl materials are available from manufacturers or companies such as glowstickfactory.com, 485 Nantasket Avenue, Hull, Mass., 02045, U.S.A. As even another preferred example, a wood grain (e.g. maple or spruce) print may be provided on a vinyl or paper material formed or cut to fit the front magnetic surface, which is more suitable for acoustic guitars. Preferably, the color or design provided on the surface of flexible magnetic body 114 is the same or similar color or design provided on each surface of guitar pick 110. If a holographic sticker material is used, for example, the same or a similar holographic surface is provided on each surface of guitar pick 110.

It is preferred that flexible magnetic body 114 be relatively thin. When flexible magnetic body 114 is kept thin, its front magnetic surface remains relatively flush with the surface of guitar body 102 so that guitar picks may be easily handled. For example, when guitar pick 110 is pressed to be slid off the edge of flexible magnetic body 114, it may get further slid along the front surface of guitar body 102 (or its edge) until it is captured by the fingers of the guitar player. Also, since flexible magnetic body 114 is so thin, when guitar pick 110 is pressed on an edge of flexible magnetic body 114 with the front surface of guitar body 102, it tilts with a relatively small angle so as maintain sufficient magnetic attraction with the front magnetic surface of flexible magnetic body 114 (i.e. it tends not to “pop” off when so depressed). A thin flexible magnetic body 114 also has a tendency to stay clear of obstructions which may jar guitar pick 110 and/or flexible magnetic body 114 off of guitar body 102. A thin flexible magnet is preferably sufficiently flexible such that it easily maintains conformity to curved surfaces (e.g. side edges) of a guitar body, even when the rear adhering layer is relatively weak (e.g. static cling vinyl). Finally, a thin constitution also helps provide flexible magnetic body 114 with the appearance of a decorative “decal” for decorating the front surface of guitar 100.

Such thin flexible magnetic material may be obtained from, for example, Magnetic Specialty, Inc. mentioned earlier. ProMAG® magnetic sheets may be obtained for this application, with thicknesses ranging from 0.25 mm (0.010 inches) to 1.5 mm (0.060 inches). These sheets may be obtained with or without laminates such as vinyl, paper, or adhesive, colored or uncolored, and used in the present application. ProMAG® is a registered trademark of Magnetic Specialty, Inc.

Although flexible magnetic body 114 may be formed with any suitable length and width, it is preferred that flexible magnetic body 114 have a length of between about 6.35 centimeters (about 2.5 inches) to 11.43 centimeters (about 4.5 inches), and a width of between about 1 centimeter (about 0.4 inches) to 2.5 centimeters (about 1 inch). Most preferably, flexible magnetic body 114 has a length of about 8.9 centimeters (about 3.5 inches) and a width of about 1.5 centimeters (about 0.6 inches), suited to fit to most electric guitars along their narrow bottom “handle” near where a guitar player's fingers generally rest. With the most preferred length and width, flexible magnetic body 114 has a surface area sufficient to hold at least three guitar picks. Note that the width of flexible magnetic body 114 need not (and preferably does not) cover the entire surface area of guitar pick 110; the surface area of flexible magnetic body 114 may cover only between about 50%-90% of each guitar pick 110. For example, flexible magnetic body 114 may cover about 90%, 75%, 66%, or 50% of the surface area each guitar pick 110.

It is also desired that flexible magnetic body 114 take on a variety of visually appealing shapes, styles, and colors. In this case, flexible magnetic body 114 may be viewed as a decorative design for a front surface of a guitar (which may include a printed decorative coloring or design). Different predetermined shapes may be provided, such as a rectangle, a star, a circle, a cross, an arrow, a diamond, one or more footprints, a lightning bolt an S-shape, a Z-shape, an arc, an ellipse, etc. The shape may be in the form of a pickguard of a guitar, and be simultaneously used for such purpose. Each of these flexible magnets, as described above, has an adhering layer on a rear surface (with a removable backing sheet which covers the adhering layer) and a front surface which provides a magnetic field (and preferably including a coloring/design and/or glossy layer). Thus, if the flexible magnet is very thin and has a decorative shape, it appears to be a cosmetic “decal” or design on the front surface of a guitar. The flexible magnets may be attached anywhere suitable on the guitar (or other objects such as guitar cases, guitar straps, etc.) for decorative design as well as for holding guitar picks.

Guitar picks. Referring back to FIG. 1, a guitar pick 110 made with both a synthetic material (e.g. a plastic, nylon, delrin, tortex, celluloid, acetal, polypropylene, etc.) and a magnetically receptive material 112 is shown. Magnetically receptive material may be or include, for example, a magnetically receptive metal (e.g. iron, nickel, or cobalt, or combination and/or alloy thereof). Metal alloys or blends of other suitable magnetically receptive materials may be utilized. Guitar pick 110 has a body which is typically formed as a generally triangular shape with a thickness of between about 0.5 mm and 2.0 mm. The body also provides two generally planar surfaces for a guitar player to grip. Planar surfaces of guitar pick 110 are preferred in the present application, as relatively large surface-to-surface contact between pick 110 and the magnet is best for keeping pick 110 held against the magnet. Alternatively, the surfaces of guitar pick 110 may be generally planar but have, for example, raised areas for text letters or design.

In the present application, guitar pick 110 is preferably formed from a combined blend of synthetic material and magnetically receptive material. In a blend, materials are mixed or combined so as to obtain a new mixture of a particular quality or consistency. Here, the magnetically receptive material may be viewed as being distributed or perhaps “sprinkled” within synthetic material. Thus, the magnetically receptive material is dispersed within the guitar pick body. In particular, the magnetically receptive material may be substantially evenly, equally, and/or uniformly distributed throughout the guitar pick body. Such a blend, which is made prior to actual formation of the guitar pick body, may be referred to as a compound. The magnetically receptive metal may also be referred to as being an “additive” to the plastic material.

Preferably, the magnetically receptive material is a metal material. For example, the magnetically receptive metal may be or include iron or iron-oxide. As other examples, the magnetically receptive material may be or include nickel or cobalt. The synthetic material may be any suitable synthetic material, such as polypropylene or nylon. Any suitable synthetic or plastic material may be used in the blend, however, including acetal, celluloid, tortex, delrin, etc. Also, any suitable blend or compound material may be utilized and obtained from any suitable plastics company having experience with such additives and compounds. It is surmised that a mechanical bond, not a chemical bond, is formed between such synthetic material and metal material. A ready-made blend of material which provides a good tradeoff in qualities of flexibility, rigidity, and magnetic receptiveness may be obtained from, for example, RTP Company of Winona, Minn., U.S.A., as Product Number RIP 199 x 100026 D, “Polypropylene (PP) Magnetically Attractable”.

The procedure for making such a guitar pick may involve receiving raw polymer materials which have an extremely fine (e.g. 10-20 micrometer) metal powder blended therewithin. This material may be injection molded using the same type of equipment and tools employed by the plastics industry. On the other hand, the blended material may be formed into thin sheets and extruded to simultaneously form multiple guitar picks. Thus, the body of guitar pick 110 may be formed from these materials using an injection molding technique or by die cutting from extruded sheets. In either case, the material is hardened and formed into guitar pick shapes. During injection molding, guitar picks are formed by melting the blended material into liquid form and forcing it into molds the shape of the desired pick. Molding produces a material where the fibers are typically arranged in a random matrix. Unless processed further, the surface of a molded pick is typically shiny and smooth. On the other hand, oftentimes plastics are extruded (force-shaped) into sheets or strips. From these extruded sheets, knife-like dies are used to stamp out the various pick shapes. The resulting pick shape must then be tumbled (in rock polishing-like tumblers) to smooth and round the edges. The extruding process sets up a grain with the fibers running in one direction. Many believe that this grain adds to a guitar pick's stiffness and durability.

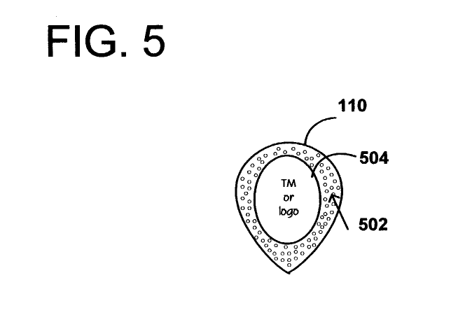

In FIG. 5, a hidden internal view of a magnetically receptive material 502 (e.g. a magnetically receptive metal, such as iron powder) is revealed as being dispersed or distributed within the synthetic or plastic material of guitar pick 110. Magnetically receptive material 502 is shown as small dispersed circles or particles in FIG. 5, which are exaggerated in size and spacing only for visual clarity and understanding. Such magnetically receptive material 502 is not normally visible as shown in FIG. 5, although the coloring of guitar pick 110 tends to be darker (dark grey or black) due to the nature of the material.

Thus, a guitar pick is made from a blend of plastic material and magnetically receptive material which forms the guitar pick body. In particular, the guitar pick may be made from a hardened mixture of synthetic and metal material (e.g. iron or iron powder) which forms the guitar pick body, where the metal material is magnetically attractable. The magnetically receptive or magnetically attractable material may be viewed as being dispersed within the guitar pick body.

Preferably, guitar pick 110 of FIG. 5 may have its magnetically receptive material 502 made to be magnetic. Here, guitar pick 110 may be magnetized after formation of its body by, for example, exposing it to a strong magnetic field for a suitable length of time. Alternatively, a magnetic powder may be used in the blend. Being magnetic, guitar pick 110 may be able to be held and carried against metal of guitar instruments and associated accessories (e.g. guitar strings, microphone stands, etc.). Such a guitar pick 110 may be configured to be magnetically attracted to and carried against a metal piece, attachable to a guitar and similar to the flexible magnet, which is provided with guitar pick 110.

In addition, the surface of guitar pick 110 preferably includes a coloring and a brand name, visual design, company name, or company logo. The surface may be more personalized as well, providing for a band name, a band logo, a band player's name, or other. Pad printing or other suitable technique may be used to provide such text or design. However, the use of the combined blend of materials (e.g. using iron) may undesirably provide limited coloring options for guitar pick 110. For example, guitar pick 110 formed from such a blend may be undesirably limited to a dark grey or black color. These limited coloring/decorative options may not be suitable where guitar picks are “on display” on one's guitar.

Therefore, a colored or designed paper, vinyl, or polyester laminate is preferably provided on at least a portion of one or both surfaces of guitar pick 110. Preferably, a vinyl laminate is provided on both sides of guitar pick 110 and a trademark name or logo is printed thereon. See a laminate 504 of FIG. 5, which includes a printed name or logo. Each laminate is die cut and sized to fit within the perimeter of a standard-sized guitar pick, and preferably includes a brand name, visual design, company name, or company logo. The laminates may be more personalized as well, providing for a band name, a band logo, a band player's name, or other. Preferably, the laminate is opaque and is sized to cover up most other color and/or any imperfections on the guitar pick itself. Such a laminate also may provide protection to reduce any possible adverse affects from oils and acids from fingers of the guitar player.

A vinyl laminate with a suitable coloring or design is preferably provided and die cut into an appropriate shape to cover most of the surface area of a guitar pick. As examples, black and white color vinyls are suitable, as are red, blue, and green. Preferably, a vinyl laminate with a holographic image is provided and die cut into an appropriate shape for each guitar pick. Also preferably, a glow-in-the-dark vinyl laminate is provided and die cut into an appropriate shape for each guitar pick. Such a “glow” imparts a great advantage for such guitar picks, as never before have picks been so readily retrievable on guitar surfaces and, when lights are minimal or off, guitar players can readily see and access them.

Such laminates may be adhesively attached to one side of guitar pick 110, and preferably guitar pick 110 has one “sticker” for each surface thereof. Guitar pick 110 may be provided with such material already adhesively attached on each surface thereof. Alternatively, each “guitar pick sticker” may be peelably removed from a backing sheet and adhered to a guitar player's own preferred guitar picks. In the preferred embodiment, the adhesive used on each guitar pick “sticker” is acrylic or an acrylic-based adhesive. Alternatively, the laminates are hot foil stamped, or cold foil stamped, on the surface of each guitar pick. Other suitable processes may be utilized. In alternative embodiments, a laminate may be shaped in a thin ring or oval, a thin straight line (horizontal or vertical), or a cross, as examples.

Final Comments. Advantageously, guitar picks can be magnetically carried on a guitar or other object for storage or for easy retrieval by a guitar player while playing. A guitar pick holder includes a magnet having a front magnetic surface for use in magnetically holding a guitar pick and a rear adhering surface for use in adhering the magnet to a surface of a guitar. The magnet is preferably made with a flexible magnet that is thin, planar, and formed into a decorative shape to provide a visually appealing design for the guitar.

In the present application, the guitar pick is made of a blend of plastic material and magnetically receptive material which forms the guitar pick body. Preferably, the magnetically receptive material is or includes iron (e.g. fine iron powder) which is dispersed or distributed within the synthetic material. Advantageously, the blend of materials provides the guitar pick with a sufficient magnetic attraction so that it can be magnetically held against the magnet, while simultaneously providing a flexibility, durability, and “look and feel” of a conventional synthetic pick. The guitar pick may be magnetized as well. A vinyl or polyester material may be provided over at least a portion of the surface of the guitar pick to provide for coloring or decoration, as such guitar picks are placed on display on the guitar. Colored, holographic, and/or “glow” laminates provide good decorative qualities, attractive marketing to different audiences, and good visibility for pick retrieval. Such guitar picks can also be made at a relatively low cost for ubiquitous use.

It is to be understood that the above is merely a description of preferred embodiments of the invention and that various changes, alterations, and variations may be made without departing from the true spirit and scope of the invention as set for in the appended claims. The guitar utilized may be an acoustic or an electrical guitar, which may be a 6-string electric guitar or a bass guitar. The flexible magnetic body may be integrally formed using a less flexible plastic (or larger quantities of plastic) to become a relatively harder and more rigid (but still flexible) magnetic body. The magnetically receptive material may be a metal, which may be from metal powder, fine metal powder, metal shavings, etc. In addition, each of the embodiments described herein may all be “reversed” such that the flexible body is integrally provided with the magnetically receptive material (e.g. metal such as iron, nickel, cobalt, etc.) and the guitar pick is made magnetic. Few if any of the terms or phrases in the specification and claims have been given any special particular meaning different from their plain language meaning, and therefore the specification is not to be used to define such terms in an unduly narrow sense.

What is claimed is:

1. A guitar pick, comprising:
a guitar pick body; and
a blend of plastic and magnetically receptive material forming the guitar pick body.

2. The guitar pick of claim 1, wherein the magnetically receptive material comprises metal.

3. The guitar pick of claim 1, wherein the magnetically receptive material comprises metal powder.

4. The guitar pick of claim 1, wherein the magnetically receptive material comprises iron.

5. The guitar pick of claim 1, wherein the magnetically receptive material comprises at least one of cobalt or nickel.

6. The guitar pick of claim 1, wherein the magnetically receptive material is blended within the plastic material.

7. The guitar pick of claim 1, wherein the magnetically receptive material comprises metal powder which is dispersed within the blend.

8. The guitar pick of claim 1, wherein the magnetically receptive material comprises iron powder which is dispersed within the blend.

9. The guitar pick of claim 1, wherein the magnetically receptive material of the blend is made magnetic.

10. The guitar pick of claim 1, wherein the magnetically receptive material of the blend includes iron which is made magnetic.

11. The guitar pick of claim 1, wherein the plastic material comprises at least one of nylon, acetal, and celluloid.

12. The guitar pick of claim 1, wherein the plastic material comprises polypropylene.

13. The guitar pick of claim 1, wherein the guitar pick body comprises a generally triangular shape and has a thickness of between about 0.5 mm and 2.0 mm.

14. The guitar pick of claim 1, being suitable for use in being magnetically carried by a magnetic material.

15. The guitar pick of claim 1, wherein the magnetically receptive material provides the guitar pick with a sufficient magnetic receptiveness to be magnetically carried against a flexible magnetic body which is adhered to a surface of a guitar.

16. The guitar pick of claim 1, further comprising:
a colored or designed laminate which covers at least a portion of a surface of the guitar pick.

17. A guitar pick, comprising:
a hardened mixture of plastic and metal material which forms a guitar pick body; and
the metal material being magnetically attractable.

18. The guitar pick of claim 17, wherein the metal material comprises iron.

19. The guitar pick of claim 17, wherein the metal material comprises metal powder.

20. The guitar pick of claim 17, wherein the metal material makes the guitar pick suitable for use in being magnetically held to a magnet.

21. The guitar pick of claim 17, wherein the metal material makes the guitar pick suitable for use in being magnetically carried by a flexible magnetic body attached to a guitar surface.

22. The guitar pick of claim 17, wherein the metal material is dispersed within the guitar pick body.

23. The guitar pick of claim 17, wherein the metal material of the blend is made magnetic.

24. A guitar pick for use in being magnetically attracted to and carried against a magnetic material, the guitar pick comprising:
a hardened mixture of synthetic and metal material which is formed into a guitar pick body;
the guitar pick body having a generally triangular shape;
the guitar pick body having two generally planar outside surfaces; and
the metal material being magnetically attractable.

25. The guitar pick of claim 24, wherein the synthetic material comprises plastic and the metal material comprises iron.
